(19) United States
(12) Patent Application Publication
(10) Pub. No.: US 2002/0020092 A1
(43) Pub. Date: Feb. 21, 2002

(54) Designer photograph album page

(76) Inventor: Iris M. Kurka, Beaver Falls, PA (US)

Correspondence Address: IRIS MARIE KURKA, COLONIAL OAKS D-84, BEAVER FALLS, PA, 15010, US

(21) Appl. No.: 09/902,129

(22) Filed: Jul. 10, 2001

Related U.S. Application Data
(60) Provisional application No. 60/217,695, filed on Jul. 12, 2000.

(51) Int. Cl. G09F 19/00

(52) U.S. Cl. 40/537

(57) ABSTRACT

The loose leaf, dual sided, designer photograph album page being presented allows for a variety of items, such as photographs, to be stored and displayed through pages depicting a particular theme or design that enhances or highlights the material being presented. Collection of the various designer album pages results in the creation of a customized and personalized photograph album that goes beyond the personal touch derived from the use of photographs and memorabilia alone.

The photo album page is of a folder type construction. Graphics artwork, designs and decorations are displayed on the outward side of a folded panel. A variety of means, such as individual pockets, can be used to hold the photographs in place on the inside of the folded panel. The photographs and memorabilia are aligned with apertures of various shapes and sizes through which they will be viewed. The apertures are shaped in order to coordinate with the graphics of that particular page.

The page can be constructed of card stock, paper board, plastic, or laminated paper. Page size will vary in order to allow the page to fit into standard size albums whether the albums are specifically made for photographs or for a more general purpose such as three ring binders. While the page will often be in the form of a rectangle or square, the shape of the page may vary so that it can be used as part of the design of the page. A plurality of holes will be placed in the margin of the page to allow it to be inserted into the albums and binders.

Some of the graphics themes displayed on the outside of the page would include, but not be limited to, those relating to holidays, seasons, special occasions, interests, events, etc. Some of the designs displayed on the page would include, but not be limited to marbleized paper, handmade paper, holographic paper, embroidered paper, etc. Additional decorations include, but are not limited to, lace, cord of various sizes and materials, charms, pins, beads, feathers, flowers, or even devices that could possibly hold some memorabilia such as a small, self-enclosed pocket, etc. The graphics and decorations may be printed directly onto the page or attached in a variety of ways as required by the particular decoration. Based on the options stated, the design and variety of the pages can be endless.

### CROSS-REFERENCE TO RELATED APPLICATIONS

This application is entitled to the benefit of Provisional Patent App. Ser. No. 60/217695.

### BACKGROUND—FIELD OF INVENTION

The invention being presented relates to the storage and display of photographs and memorabilia in uniquely designed pages that allows for the development of photograph albums that are customized and personalized beyond the mere inclusion of the photographs and memorabilia themselves.

### BACKGROUND—DESCRIPTION OF PRIOR ART

Photograph albums have been around since the invention of the camera. Such albums developed into scrapbooks with the addition of memorabilia such as locks of hair, newspaper clippings, dried flowers, etc.

The art or craft of scrapbook making made a major advancement within the last several years when special designer papers were made available to the public. Basically, photographs are attached to specially cut-out borders, which in turn are attached to the designer paper. Stickers with captions might then be applied, or the captions may be written directly onto the designer paper. Often, the whole packet is then slipped into a clear 8½×11 acid free page protector.

The photographs are often drastically cut in order to fit into the design of the page. For example, the image of a child may be cut out in the form of a star, attached to a larger cut-out star that was cut from sparkle paper, and then attached to a designer paper with the graphics of a smiling quarter moon on it.

The ideas for scrapbooks are unlimited and the results are quite fabulous, but the process offers quite a few drawbacks. Creation of such pages often demand a great deal of time. The crafters must possess a certain amount of talent or desire to engage in such an activity. If the person is working alone, the cost of tools and supplies can be expensive and wasteful if the the person loses interest in the craft after making only a few pages.

As mentioned, the photographs are permanently attached to the page allowing little room for error and no room for change. In additions, the photographs are regularly cut, often drastically, either around the image of a person or into shapes such as hearts, stars, flowers, etc. This again leaves little room for error and if there is a change in plan, the crafter may regret the irreversible change made to the photograph.

Most important, in order to create a scrapbook page, the photographs must be in-hand in order to design the page around them. Thus, creating scrapbook albums for gifts and distribution to the general public is difficult; and if not impossible, then very expensive.

Some progress has been made in the design of more elegant picture albums such as U.S. Pat. No. 5,816,730 to Alspaw and Harris. They offer a photograph display book where photos are applied to the pages of a book. The photos are displayed in conjunction with captions and pictorial representations that ultimately create a theme or story. Here the photographs are, again, permanently attached to the page. The pages are bound together in book form not permitting the change of pages or the choice of pages to be included in the book. Finally, each page receives one photograph which limits a person's ability to display all of his or her photographs in such a manner.

U.S. Pat. No. 3,642,552 to Sibley offers a photograph album leaf of closed pocket construction. Access to the pockets are with slots on the reverse side between the pages. Preprinted decorative borders define the pocket frames in an orderly manner across the page. Simple repetitive borders around rows of orderly displayed photographs accomplishes it's job of protecting and displaying photographs, but consumers today want a more creative, personal way to display their precious memories as seen by today's popular scrapbook making craft.

In U.S. Pat. No. 5,096,752, Wagner discloses a place mat which provides for the display of cards. The mat displays graphics related to the cards displayed. Because of the item itself, the mats are used to display cards and not photos and are not well suited for collecting and displaying a large number of photos even if photos were used instead of cards.

U.S. Pat. No. 3,797,146 to Holes; U.S. Pat No. 3,735,516 to Wenstrom, and U.S. Pat. No. 5,957,502 to Manico and Reem, all offer a dual sided photograph album for a plurality of photographs. Again, they allow the photographs to be protected and displayed in an orderly way, but the lack of graphics limits the value and desirability of these methods, again, as seen by today's scrapbook making.

U.S. Pat. 5,787,617 to Teste offers a multi-panel display device where photographs are viewed through die cut apertures in the outer panel. The outer panel has graphics printed round the die cuts in such a way as to give the appearance of interaction between the subject of the photograph and the scene depicted in the graphics. The photographs are held between the panels and only the face of the subjects of the photographs are seen through the apertures. The pages are bound so one is unable to add or change the pages in the display device. While unique, this device would not be a suitable method of storing and displaying a lifetime's worth of photographs.

Rubens, in U.S. Pat. No. 4,965,948 offers a bidirectional album for the storage of photographs. The photographs may be retained in either a latitudinal or longitudinal vertical orientation. Room for memos or captions regarding the photographs have been made in a column in the margin area and the pages are bound by a spiral ring. While having an area for captions and memos is an advancement over albums that just display the photographs, the inability to add and change pages and the lack of graphics again severely limits the desirability of this album in light of the desire for a more personalized photograph album.

### SUMMARY

In accordance with the present invention, a designer photograph album page is comprised of a folded panel or page with graphics, designs, artwork, or decorations on one side, a plurality of various shaped and sized apertures in the page through which photographs are displayed, a means such as pockets to hold the photographs against the apertures on the side opposite the graphics, and a plurality of small holes on the edges of the page so it can be inserted into a photograph album or general use binder

### OBJECTS AND ADVANTAGES

From the description above, a number of advantages of my designer photograph album page include the ability:

(a) to provide attractively designed photograph album pages to those who do not posses the time, talent, creativity, or desire to develop such decorative pages.

(b) to provide attractively designed photograph album pages to those who could not afford the tools and materials needed to create such pages or to those who could not afford to have designer pages created for them.

(c) to provide attractively designed photograph album pages that permits the photographs to remain intact, while allowing the entire photograph to be incorporated into the design of the page through use of the different shaped and sized apertures.

(e) to provide attractively designed photograph album pages that allow the easy removal and exchange of photographs from and between the album pages.

(f) to provide the ability to purchase and give designer photograph album pages while eliminating the need to know the exact content of the photographs to be used.

(g) to provide the ability to develop a tailored photograph album based on the photographs and number of pages needed in relation to various themes and decorations.

(j) to provide the ability to develop an expandable album to store a large number of photographs based on the ability to collect and add individual pages to the album.

(k) to provide the ability to display photographs is such a way that enhances and increases the enjoyment of viewing the photographs.

### BRIEF DESCRIPTION OF THE DRAWINGS

FIG. 1 is the unfolded front view of the loose leaf, dual sided, photograph album page with the graphics relating to a theme that utilizes round and square apertures.

FIG. 2 is the unfolded inside view of FIG. 1 showing the arrangements of pockets holding the photographs and how they correspond to the apertures in the page.

FIG. 3 is the top sectional view of a folded album page.

FIG. 4A is the view of a single pocket used to hold photograph up to the aperture with the pocket attached to the panel with the use of a permanent adhesive on three edges.

FIG. 4B is the partial view of FIG. 2 using corner tabs to hold photograph up to the aperture with tabs attached to the page with the use of a permanent adhesive.

FIG. 4C is the partial view of FIG. 2 using small corner cuts to hold photograph up to the aperture by inserting the corners of the photographs into small corner cuts.

FIG. 4D is the partial view of FIG. 2 using strips to hold the photograph up to the aperture with the strips attached to the page with the use of a permanent adhesive.

FIG. 4E is the partial view of FIG. 2 using ridges to hold the photograph up to the aperture with the ridges attached to the page with the use of a permanent adhesive on two edges of the ridge.

FIG. 4F is the partial view of FIG. 2 using reusable adhesive to hold the photograph directly onto the page.

FIG. 4G is the unfolded inside view of FIG. 1 using a center sheet to hold the photos.

### Reference Numbers In Drawings

| | |
|---|---|
| 6 | front view of entire panel |
| 8 | fold dividing panel into page |
| 10a & 10b | theme type graphics |
| 12 | front view of square aperture |
| 14 | front view of round apertures |
| 16a & 16b | front halves of panel/pages |
| 18 | front view of various photos |
| 20 | front view of holes |
| 22 | inside view of folded page |
| 24 | edge of pocket |
| 26 | back of photo while in pocket |
| 28 | outline of hidden apertures |
| 30 | folded panel or album page seen from a top |
| | sectional view |
| 32 | various photographs seen in pockets from a top |
| | sectional view |
| 34 | pockets seen from a top sectional view |
| 36 | alignment of small holes from a top sectional view |
| 38 | individual pocket |
| 40 | permanent adhesive |
| 42 | edge of aperture |
| 43 | partial view of the inside of page |
| 44 | back of photograph |
| 45 | permanent adhesive |
| 46 | hidden edge of aperture |
| 48 | corner tab |
| 50 | corner of picture in tab |
| 51 | partial view of the inside of a page |
| 52 | back of photograph |
| 54 | hidden edge of aperture |
| 56 | corner cut |
| 58 | corner of photo in corner cut |
| 59 | partial view of the inside of a page |
| 60 | back of photograph |
| 62 | hidden edge of aperture |
| 64 | corner strap |
| 66 | adhesive connecting strap to page |
| 67 | partial view of the inside of a page |
| 68 | back of photograph |
| 70 | hidden edge of aperture |
| 72 | ridges |
| 74 | adhesive connecting ridge to page |
| 76 | entry area of ridge no adhesive |
| 78 | direction photo is slid into ridge |
| 79 | partial view of the inside of a page |
| 80 | back of photograph |
| 82 | hidden edge of aperture |
| 84 | reusable adhesive |
| 86 | unfolded inside of page |
| 88 | edge of aperture from inside view |
| 90 | center page |
| 92 | photos mounted on center page |
| 94 | small holes for binder rings |
| 96 | small holes on center page |

### DESCRIPTION OF PREFERRED EMBODIMENTS

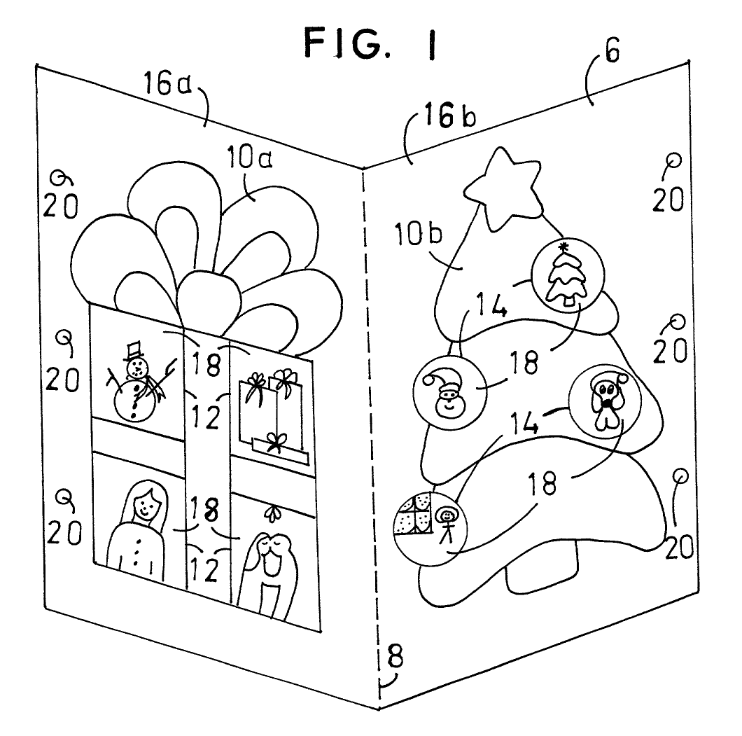

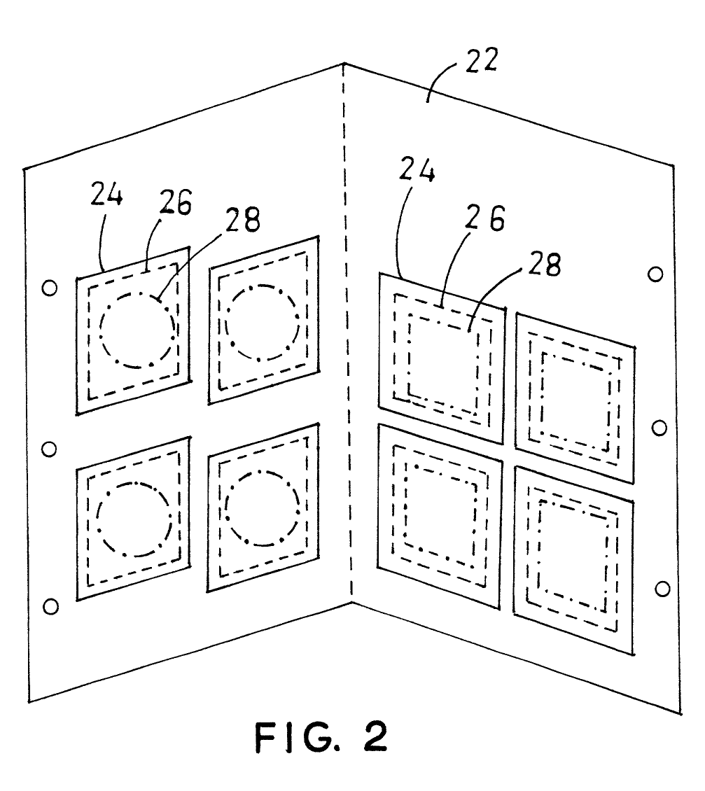

FIG. 1 shows the unfolded front view of a panel 6 which, when folded 8, becomes the front and back of a single page of the album. The size of the panel and page will vary based on the photo album or general use binder that the page is intended for. Each page, or two halves of the panel 16a & 16b, depict graphics 10a & 10b and contain a plurality of apertures 12 & 14 whose shapes and sizes are related to the graphics. On FIG. 2, the pockets 24 on the inside section of the panel correspond with the apertures in the panel and allow the front of the photograph 18 to be displayed through the apertures 12 & 14. A plurality of holes 20 are placed in the margin along the edges furthest from the fold 8 so the page can easily be folded closed and inserted into a photograph album or general use binder.

FIG. 2 is the inside view of the panel 22. Pockets 30 are used to hold the photos 26 in alignment with the apertures 28 so that the photos can be seen through the apertures FIG. 1 12 & 14 with the back of the photograph facing the pocket 26.

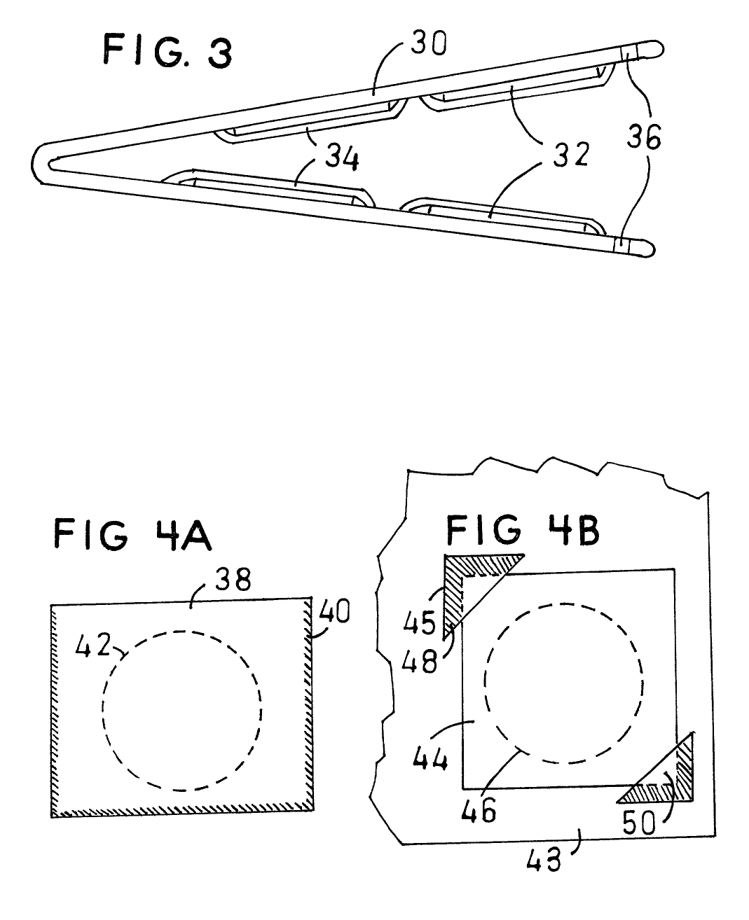

FIG. 3 is a top sectional view showing the folded panel 30, the photographs 32, the pockets 34 holding the photographs, and the alignment of small holes 36 used to insert the page into an album or binder.

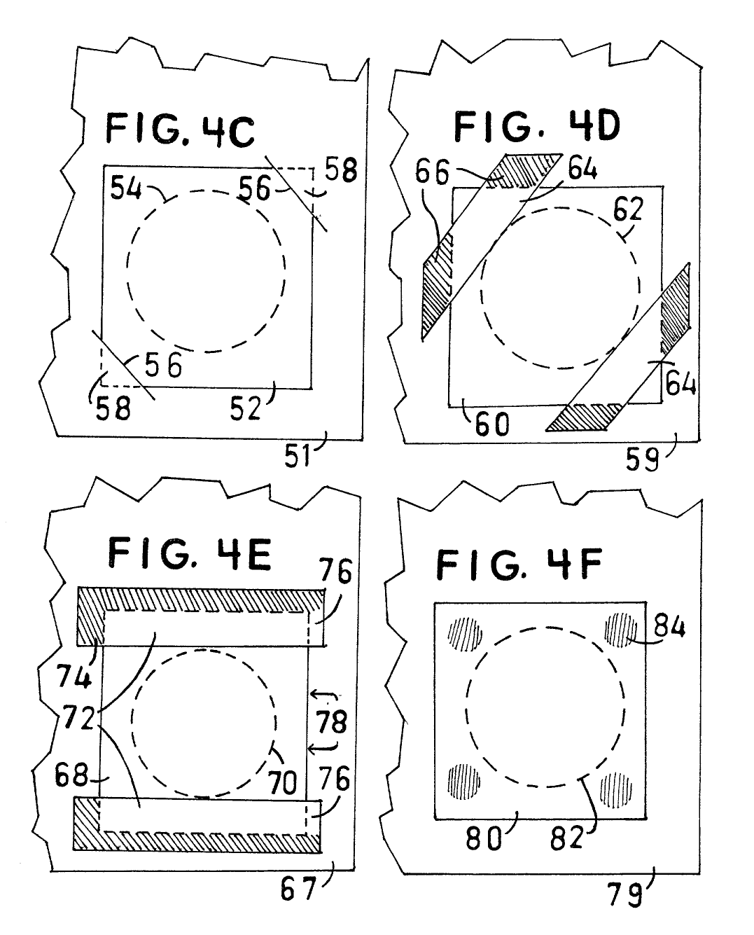

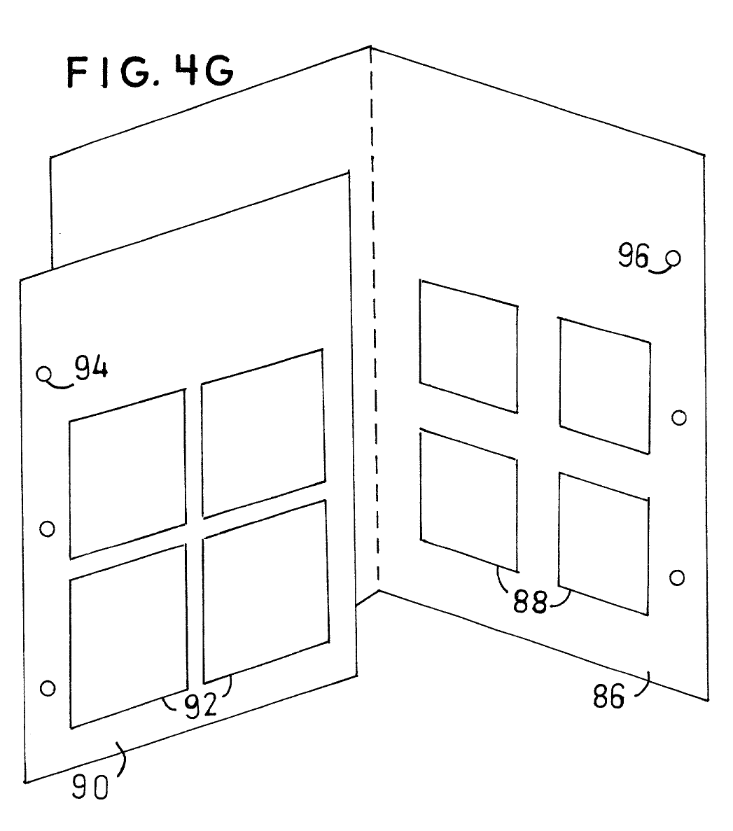

FIG. 4A shows an individual pocket 38 used to hold the photographs in place so they can be seen through the apertures. The pockets vary in size both length and width allowing for as much room as possible for the photograph. The bottom edge of the aperture should be situated above the inside edge of the pocket 42 to allow the edge of the photograph to rest. Three edges of the pocket 40 are lined with a permanent adhesive so that the pocket can be attached to the folded panel.

FIG. 4B-4G—Alternative Embodiments

There are various possibilities with regard to how the photograph can be held in place behind the aperture so that the photograph is viewed through the aperture. Keeping in mind that the photographs are to be easily inserted and easily removed for quick exchange between pages, the stated pockets are the preferred method of holding the photographs, but the following alternatives can also be used if one is so inclined.

FIG. 4B shows a partial inside view of a panel 43 with the photograph 44 being held to the aperture 46 with corner tabs 48 attached to the page with permanent adhesive 45 and the corner of the photograph shown inserted in the tabs 50.

FIG. 4C shows a partial inside view of a panel 51 with the photo 52 being held to the aperture 54 using two small cuts 56 and the corner of the photo in the cuts 58.

FIG. 4D shows a partial inside view of a panel 59 using corner straps 64 to hold the photograph 60 to the aperture 62.

FIG. 4E shows a partial inside view of a panel 67 using ridges 72 with permanent adhesive on two sides of the ridge 74 so the photographs 68 can slide into place 78 on the section of the ridge without adhesive 76 in order to be held to the apertures 70.

FIG. 4F shows a partial inside view of a panel 79 using a reusable adhesive material 84 on the page itself that would hold the photograph 80 to the aperture 82.

FIG. 4G shows the center sheet 90 with precise placement of photographs 92 so they will be held to the apertures 88 when the sheet is placed inside the folded page 86 using any means already mentioned to hold the photographs to the center sheet.

Operation

The owner of the designer album page would unfold the panel 6, slide the chosen photographs 18 into the pockets 24 located on the inside view of the panel 22 so that the photographs show through the apertures 12 & 14. The photographs 18 could also be slid into corner tabs 48, small corner cuts 56 in the page, corner straps 64, ridges 72, attached to reusable adhesive material 84, or be placed on a center sheet 90 to be held up to the apertures 12 & 14. They would then fold the panel and place the page 30 into a photograph album or general use binder by threading the open binder rings through the holes at the edges of the page 20 and then closing the rings. This would allow for the page to be stored in the album and keep the page folded in order to view the graphics and photographs.

### CONCLUSIONS, RAMIFICATIONS, AND SCOPE

It is believed the reader will see that the pages are a creative and desirable way to store, protect, and display photographs and that collection of such pages allows the development of a uniquely customized and personalized photograph album. As seen in the prior art, photo albums thus far are plain, void of enhancing decorations and graphics; are bound, not allowing for expansion; and are limited, displaying one photograph or part of a photograph or one theme. Designer photo album pages have, up to now, only been available to crafters who posses the time, talent, creativity, finances, and desire to invest in creating such pages. The crafters also need to have the photographs they plan to design around in hand. My invention has several advantages.

it saves on the investment of time, talent, finances, and desire.

it allows the public to purchase and give designer pages without the need to have the photographs available at time of purchase.

it is flexible and allows for the exchange of photos and the rearrangement of pages

it highlights and enhances the display of photographs and memorabilia through use of themes, decorations, artwork, designs, colors, textures, etc.

it is expandable allowing for the addition of as many pages needed to hold and display a great number of photographs. The only limit would be the size of the binder used to hold the pages.

Although the description above contains many specificities, these should not be construed as limiting the scope of the invention but as merely providing illustrations of some of the presently preferred embodiments of this invention. The scope of the invention should be determined by the appended claims and their legal equivalents, rather than by the examples given.

I claim:

1. A designer photograph album page for the storing and displaying photographs and memorabilia on pages that accentuates and enhances the items being displayed; allowing for the development of an expandable customized photographs album; and consisting of a folded sheet with graphics, artwork, designs, and/or decorations on the outer side of the folded sheet, a plurality of apertures in the sheet through which the photographs are viewed, a means to hold the photographs to the apertures, and a plurality of small holes along one edge of the page used to insert the page into a photo album or general use binder.

2. The designer album page of claim 1 wherein the material of the folded page is made of card stock, paper board, laminated paper, or plastic.

3. The designer album page of claim 1 wherein the graphics, artwork, and/or decorations contained on the outside of the folded page are printed on, etched or drawn on, glued on, laminated to, stapled to, tied to, or sewn into the album page

4. The designer album page of claim 1 wherein the folded page itself may be trimmed or cut into various shapes such as flowers, bugs, trains, etc., so to be better integrated into the overall design of the page.

5. The designer album page of claim 1 wherein the graphics, artwork, and/or decorations relate to an activity, event, holiday, experience, celebration, interest, or place.

6. The designer album page of claim 1 wherein the decorations and designs provide a complementary setting to the photograph by means of color, texture, and type of decoration such as buttons, lace, ribbons, and any other item that can be used as a decoration.

7. The designer album page of claim 1 wherein the apertures of various sizes also vary in shapes from circles and squares to stars and flowers or whatever shape complements the graphics, artwork, and/or decorations displayed on that page.

8. The designer album page of claim 1 wherein the apertures are of such size as to display the greater portion of a photograph rather than a targeted segment of said photograph.

9. The designer album page of claim 1 where the use of individual pockets are used on the inside of the folded panel to hold the photographs to the apertures so that the photographs can be seen through the apertures.

10. The designer album page of claim 1 where the use of two to four corner tabs are used on the inside of the folded page to hold the photographs to the apertures so the photographs can be seen through the apertures.

11. The designer album page of claim 1 where the use of two to four small cuts in the page around the apertures are used to hold the photographs to the apertures on the inside of the page so the photographs can be seen through the apertures.

12. The designer album page of claim 1 where the use of strips/straps of paper or plastic are used to hold the photographs to the apertures on the inside of the page so the photographs can be seen through the apertures.

13. The designer album page of claim 1 where the use of ridges constructed so photographs can be slid into them, are placed on both sides of the apertures on the inside of the page to hold the photographs to the apertures.

14. The designer album page of claim 1 where a reusable adhesive material is placed on the inside of the page around the apertures to hold the photographs to the apertures so the photographs can be seen through the apertures.

15. The designer album page of claim 1 where the photographs are precisely placed on a center sheet of paper, using any of the methods previously mentioned, to attach the photographs and hold them to the apertures when the center page is placed within the folded page.

16. The designer album page of claim 1 wherein the holes used to hold the pages in an album or binder are placed on the edges opposite the fold in the page.

17. The designer album page of claim 1 wherein the holes used to hold the pages in an album or binder are placed on the edges vertical of the fold in the page.
